(19) United States
(12) Patent Application Publication
(10) Pub. No.: US 2014/0028538 A1
(43) Pub. Date: Jan. 30, 2014

(54) FINGER MOTION RECOGNITION GLOVE USING CONDUCTIVE MATERIALS AND METHOD THEREOF

(71) Applicants: Hang-Sik Shin, Yongin-si (KR); Jung-Hoon Park, Seoul (KR); Sung-Joo Ahn, Seoul (KR); DaeEun Kim, Seoul (KR); Jaehong Lee, Yongin-si (KR); Eunseok Jeong, Seoul (KR)

(72) Inventors: Hang-Sik Shin, Yongin-si (KR); Jung-Hoon Park, Seoul (KR); Sung-Joo Ahn, Seoul (KR); DaeEun Kim, Seoul (KR); Jaehong Lee, Yongin-si (KR); Eunseok Jeong, Seoul (KR)

(73) Assignees: INDUSTRY-ACADEMIC COOPERATION FOUNDATION, YONSEI UNIVERSITY, Seoul (KR); SAMSUNG ELECTRONICS CO., LTD., Suwon-si (KR)

(21) Appl. No.: 13/560,849

(22) Filed: Jul. 27, 2012

(51) Int. Cl. G06F 3/033

(52) U.S. Cl. 345/156

(57) ABSTRACT

According to one embodiment, a finger motion recognition glove using conductive materials configured to detect the bending of fingers using a characteristic in which the glove which is made of conductive fibers. The finger motion recognition glove includes pairs of contacts, positioned on corresponding pairs of locations on the glove where knuckles of fingers are bent, each pair of contacts coupled to a first surface of the glove, the finger region between each of the pairs of contacts having a resistance value that changes as the corresponding finger region of the glove is bent and unbent.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jul. 27, 2011 and assigned Serial No. 10-2011-0074508, the entire disclosure of which is hereby incorporated by reference.

### TECHNICAL FIELD OF THE INVENTION

The present invention generally relates to motion recognition devices, and more particularly, to a finger motion recognition glove using conductive materials and a method thereof.

### BACKGROUND OF THE INVENTION

Currently, intelligent robots techniques are being developed in many fields. Development of techniques and equipment for disabled people are also increasing. For example, Korea's disabled population is currently about 2.4 million in 2009, which is approximately 5% of the total population. Of this, about 10% of the Korea's disabled population is classified into those having hearing-impaired and speech disorders.

In the U.S., the hearing-impaired population is about two million, which is a relatively large number of people For these people, sign language is a principle means of communication. Korean sign language includes sign language words of 5000 or more, 31 finger alphabets, and 26 finger numbers. U.S. sign language also includes words of 6000 or more, 26 finger alphabets, 26 finger numbers.

In general, people having hearing-impaired and speech disorders talk to others using sign language. It is difficult for people having hearing-impaired and speech disorders to communicate with the general public who do not know sign language. Accordingly, a finger alphabet recognition sensor glove for disabled people has been developed. There exists techniques in which it is possible for disabled people to communicate with the general public in a relatively easy manner.

### SUMMARY OF THE INVENTION

To address the above-discussed deficiencies of the prior art, it is a primary object to provide at least the advantages described below. Accordingly, an aspect of the present invention is to provide a data glove for the purpose of recognizing a sign language motion.

Another aspect of the present invention is to provide a finger motion recognition glove using conductive materials for recognizing the bending of fingers using a characteristic in which a glove is made of a conductive fiber material that may function as a sensor.

Another aspect of the present invention is to provide a data glove capable of being made relatively inexpensive without overly burdening the sign language motion process.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example finger motion recognition glove using conductive materials according to one embodiment of the present invention;

FIG. 2 illustrates respective contacts of an example finger motion recognition glove using conductive materials according to one embodiment of the present invention;

FIG. 3 illustrates an example configuration of a finger motion recognition glove using conductive materials according to one embodiment of the present invention;

FIG. 4 illustrates example positions of output resistors configured on a finger motion recognition glove using conductive materials according to one embodiment of the present invention;

FIG. 5 illustrates an example position of an analog to digital A/D converter according to one embodiment of the present invention; and

FIG. 6 illustrates an example finger operation recognition method using conductive materials according to one embodiment of the present invention.

### DETAILED DESCRIPTION OF THE INVENTION

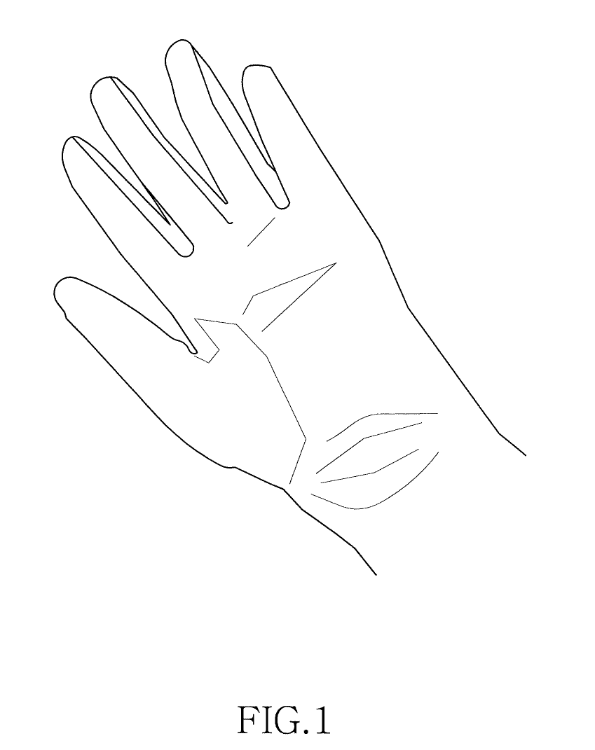

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged motion recognition devices. Exemplary embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the terms may vary depending on user's or operator's intension and usage. That is, the terms used herein must be understood based on the descriptions made herein.

FIG. 1 illustrates an example finger operation recognition glove using conductive materials according to one embodiment of the present invention.

As shown in FIG. 1, there is no significant difference between the example finger motion recognition glove using the conductive materials according to one embodiment of the present invention and an ordinary glove. However, the conductive materials from which the glove is made are made of conductive fibers. If an organic polymer, such as polyacetylene in which a carbon-carbon single bond and a carbon-carbon double bond are alternately conjugated, is doped by an electron acceptor, such as iodine, it may form a good conductor relative to metal having an electroconductivity of approximately 2×104 Ω−1•cm−1. However, there have been no materials which are made of a fiber having this level of electroconductivity. Accordingly, one feature of the present invention includes carbon particles are mixed with polymer materials to form a fiber having relatively good electroconductivity.

The present invention uses electromagnetic shielding fibers or antistatic packing materials, and the like. These materials have a conductive coating on their surface. The electromagnetic shielding fibers or the antistatic packing materials have resistance on the order of several Kilo-ohms (KΩ). Also, electric resistance on specific two points may be changed according to bending of the fibers. If a glove is made from this characteristic, a resistance value between specific two points may be changed as fingers of the glove are flexed between an unbent and a bent position. Thus, motions of fingers may be measured through the change of the resistance value.

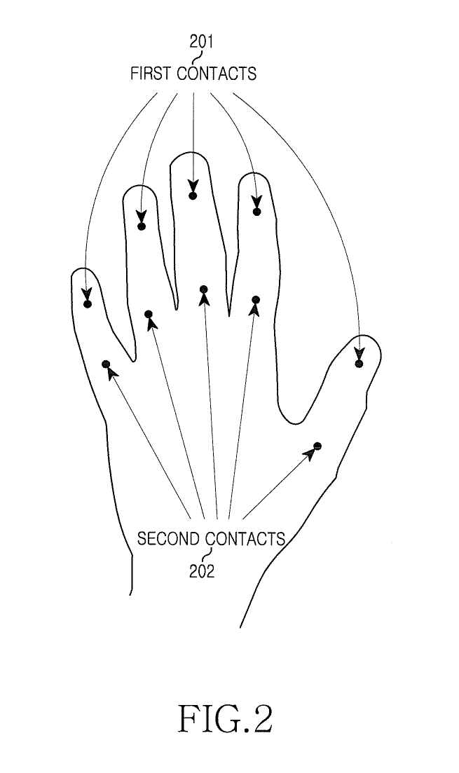

FIG. 2 illustrates several contacts of a finger motion recognition glove using conductive materials according to one embodiment of the present invention.

As shown in FIG. 2, pairs of contacts are attached to certain locations on the gloves where knuckles are typically bent per finger on a first surface (upper surface or lower surface) of the glove which is made of the conductive materials. That is, because resistance in the glove may change according to pressure between fingers, each pair of contacts, such as the upper parts of a first knuckle and a second knuckle, upper parts of the first knuckle and a third knuckle, or upper parts of the second knuckle and the third knuckle may be used as contacts. additionally, the upper parts of a first knuckle and a second knuckle of the thumb may be used as contacts.

The contacts may include first contacts 201 having five contacts attached on the upper parts of the respective five fingers of the glove and second contacts 202 having five contacts attached on lower parts of the respective five fingers of the glove. Accordingly, as described above, the glove according to the present invention is made of conductive fibers such that, as a user bends and unbends fingers, resistance values between the first contact points 201 and the second contacts 202 are changed. Thus, the motions of fingers may be measured through the change of the resistance values.

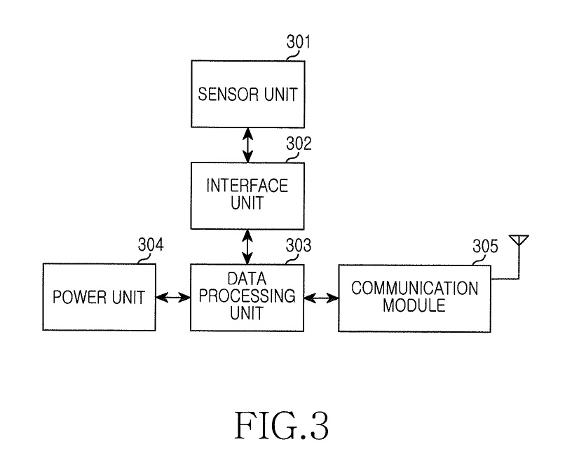

FIG. 3 illustrates an example configuration of a finger motion recognition glove using conductive materials according to one embodiment of the present invention.

As shown in FIG. 3, the finger motion recognition glove using conductive materials according to one embodiment of the present invention may include multiple sensor units 301, multiple interface units 302, a data processing unit 303, a power unit 304, and a communication module 305.

Each of sensor units 301 is positioned between each of the first contacts 201 and each of the second contacts 202 of FIG. 2. In a case of a glove configured to cover five fingers of a human hand, five sensor units 301 may be positioned from a thumb to a ring finger on the glove. As fingers are bent, internal resistance of each of the sensor units 301 changes.

Each of the interface units 302 is coupled to each of the second contacts 202. Each of the interface units 302 receives data generated by each of the sensor units 301 and sends the received data to the data processing unit 303. The interface units 302 may include an Analog to Digital (A/D) converter.

The data processing unit 303 is coupled to each of the interface units 302. The data processing unit 303 receives the data sent from each of the interface units 302 and processes the received data.

The power unit 304 is coupled to the data processing unit 303 and supplies power to the data processing unit 303.

The communication module 305 receives the data processed in the data processing unit 303 and transmits and receives the data.

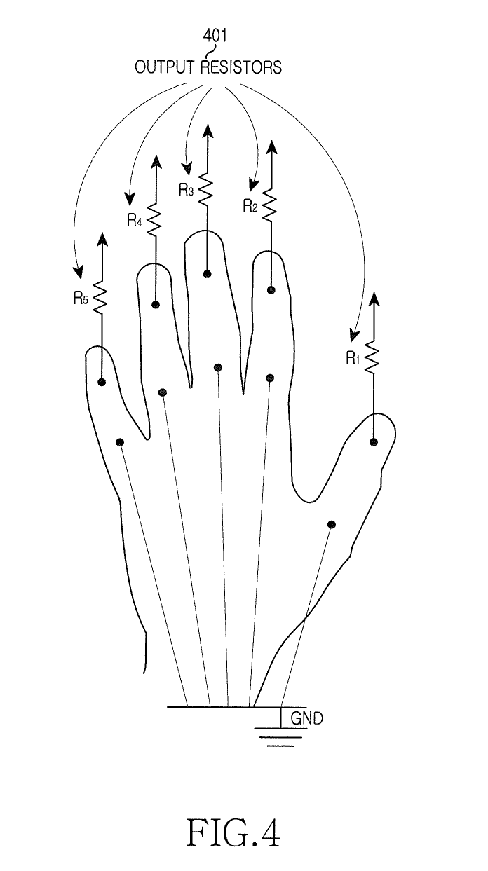

FIG. 4 illustrates example positions of output resistors in a finger motion recognition glove using conductive materials according to one embodiment of the present invention.

As shown in FIG. 4, the total five first contacts 201 of FIG. 2 are connected with output resistors (R₁-R₅: 401), each of the output resistors 401 have a certain resistance value, and the total five second contacts 202 of FIG. 2 are coupled to a ground (GND) potential.

The reason for coupling the total five output resistors 401 with the first contacts 201 is to measure a terminal voltage of each of the sensor units 301 as an internal resistor value as each of the sensor units 301 changes. That is, as a user bends and unbends fingers while wearing the glove, the internal resistor value of each of the sensor units 301 may change. A changed terminal voltage of each of the sensor units 301 may be measured according to the internal resistance value of each of the sensor units 301. Accordingly, changes to the terminal voltage of each of the sensor units 301 may be measured for detecting the motions of the fingers.

The resistance value of each of the output resistors 401 may be selected according to resistance changes of each finger. A method of obtaining an output resistor value optimized for each finger is calculated by Equation (1) below.

$${V}_{S} = {V}_{IN} \times \frac{{R}_{S}}{{R}_{S} + {R}_{I}} \qquad ( 1 )$$

A terminal voltage (voltage input to an Analog to Digital (A/D) converter) of each of the sensor units 301 may obtained, as described above, according to the voltage divider rule.

Herein, respective symbols are defined as follows.

V_{S}: a terminal voltage of each of sensor units

V_{IN}: a voltage supplied to each of fingers

R_{S}: an internal resistor of each of sensor units

R_{I}: an output resistor of each of fingers

$$VD = {V}_{IN} \times \frac{{R}_{F}}{{R}_{I} + {R}_{F}} - {V}_{IN} \times \frac{{R}_{B}}{{R}_{I} + {R}_{B}} \qquad ( 2 )$$

When each of fingers is flexed from a bent to an unbent position, a terminal voltage (a voltage input to an A/D converter) of each of the sensor units 301 may be obtained by measuring a difference between a terminal voltage when each of fingers is unbent and a terminal voltage when each of fingers is bent.

Herein, respective symbols are defined as follows.

VD: voltage difference (difference between voltages when each of fingers is unbent and bent)

R_{F}: an internal resistor of each of the sensor units when each of fingers is unbent

R_{B}: an internal resistor of each of the sensor units when each of fingers is bent

R_{I}: an output resistor of each of fingers

Equation (2) is arranged by a quadratic equation for R_{I}. If an R_{I} value is arranged according to root's formulas,

$${R}_{I} = \frac{- A + \sqrt{B}}{2} .$$

For convenience of calculation, A and B values are replaced with the following values.

$$A = {R}_{B} + {R}_{F} - \frac{{V}_{IN} {R}_{F}}{VD} + \frac{{V}_{IN} {R}_{B}}{VD} \\ B = {\{ {R}_{B} + {R}_{F} - \frac{{V}_{IN} {R}_{F}}{VD} + \frac{{V}_{IN} {R}_{B}}{VD} \}}^{2} - 4 {R}_{F} {R}_{B} \\ {R}_{I , OPTIMAL} = \frac{- A + \sqrt{B}}{2} \qquad ( 3 )$$

Herein, an optimum value of R_{I} may be obtained when a recognition rate is a maximum value (VD_{MAX}). At this time, R_{I} may be obtained by Equation (3) above.

For convenience of calculation. A and B values are replaced with the following values.

$$A = {R}_{B} + {R}_{F} - \frac{{V}_{IN} {R}_{F}}{{VD}_{MAX}} + \frac{{V}_{IN} {R}_{B}}{{VD}_{MAX}}$$

$$B = {\{ {R}_{B} + {R}_{F} - \frac{{V}_{IN} {R}_{F}}{{VD}_{MAX}} + \frac{{V}_{IN} {R}_{B}}{{VD}_{MAX}} \}}^{2} - 4 {R}_{F} {R}_{B}$$

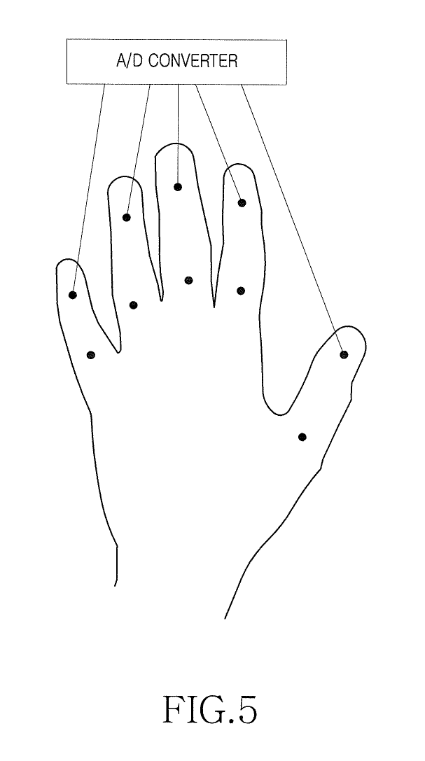

FIG. 5 illustrates an example position of the A/D converters as the interface unit shown in FIG. 3 according to one embodiment of the present invention.

As shown in FIG. 5, each A/D converter is coupled to each output resistor. As such, a terminal voltage of each of the sensor units may be measured according to the voltage divider rule. The A/D converter converts an analog voltage measured in each of the sensor unit into a digital signal. Thus, the motions of the fingers may be detected by the converted digital voltage.

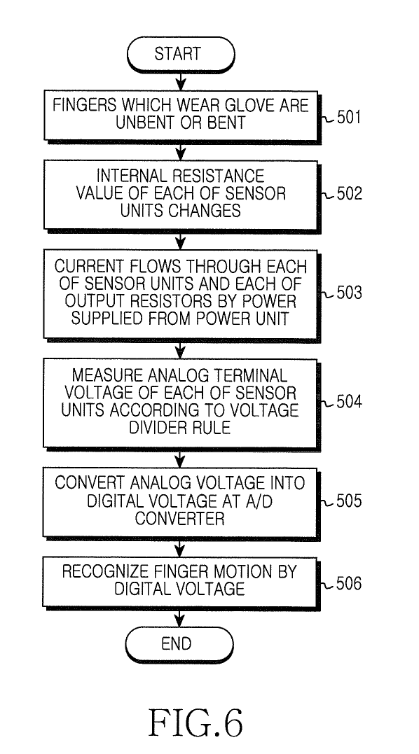

FIG. 6 illustrates an example finger motion recognition method using conductive materials according to one embodiment of the present invention.

As shown in FIG. 6, if fingers which wear a glove which is made of conductive materials is unbent or bent (step 501), an internal resistance value of each of sensor units, which is positioned between each of first contacts and each of second contacts, changes (step 502). Current flows through the contacts and each of output resistors coupled to each of the first contacts (step 503). A terminal voltage associated with the internal resistance between the contacts of each of the sensor units and each of the output resistors is measured according to the voltage divider rule (step 504). An A/D converter converts an analog voltage measured in each of the sensor units into a digital signal (step 505). A finger motion of a user is therefore detected by the digital signal converted in step 505 (step 506). Thereafter, the finger motion recognition method of FIG. 6 is ended.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A finger motion recognition glove comprising:
multiple pairs of contacts, positioned on corresponding pairs of locations on the glove where knuckles of fingers are bent, each pair of contacts coupled to a first surface of the glove which is made of conductive materials;
a plurality of interface units each coupled to a first contact of the pairs of contacts, each of the first contacts positioned on an upper part of a corresponding finger region of the glove; and
a data processing unit coupled to the interface units;
wherein the finger region between each of the pairs of contacts has a resistance value that is configured to change as the corresponding finger region of the glove is unbent and bent,
wherein each of the interface units is configured to receive data signal generated in each of the pairs of contacts and transmit the received data signal to the data processing unit.

2. The finger motion recognition glove of claim 1, wherein each of the interface units includes an A/D converter.

3. The finger motion recognition glove of claim 2, further comprising:
a power unit configured to supply power to the data processing unit; and
a communication module configured to receive the data processed in the data processing unit and transmit the processed data.

4. The finger motion recognition glove of claim 2, further comprising a plurality of output resistors, each of the output resistors coupled between each of the first contacts and the A/D converters.

5. The finger motion recognition glove of claim 4, wherein a second contact of the pairs of contacts is coupled to a ground.

6. The finger motion recognition glove of claim 2, wherein the A/D converter is configured to convert a measured analog voltage of each of the pairs of contacts into a digital signal.

7. The finger motion recognition glove of claim 6, wherein the measurement of the analog voltage of each of the pairs of contacts is configured to be performed by measuring a terminal voltage of an internal resistance of each of the pairs of contacts between each of output resistors and the internal resistance value of each of the pairs of contacts according to a voltage divider rule.

8. A finger motion recognition method comprising:
providing multiple pairs of contacts positioned on corresponding pairs of locations on a glove where knuckles of fingers are bent, each pair of contacts coupled to a first surface of the glove which is made of conductive materials;
providing a plurality of interface units each coupled to a first contact of the pairs of contacts, each of the first contacts positioned on an upper part of a corresponding finger region of the glove; and
processing data signals from the interface units to generate output data,
wherein the finger region between each of the pairs of contacts having resistance value that changes as the corresponding finger region of the glove is unbent and bent.

9. The finger motion recognition method of claim 8, each of the interface units includes an A/D converter.

10. The finger motion recognition method of claim 9, further comprising:
supplying power to the data processing unit using a power unit; and
receiving the output data processed in the data processing unit and transmitting the output data using a communication module.

11. The finger motion recognition method of claim 9, further comprising coupling output resistors between each of the first contacts and the A/D converter.

12. The finger motion recognition method of claim 11, further comprising coupling a second contact of the pairs of contacts to a ground.

13. The finger motion recognition method of claim 9, further comprising converting, using each A/D converter, a measured analog voltage of each of the pairs of contacts into a digital signal.

14. The finger motion recognition method of claim 13, further comprising measuring the analog voltage of each of the pairs of contacts by measuring a terminal voltage of an internal resistance of each of the finger regions between each of output resistors and the internal resistance value of each of the pairs of contacts according to a voltage divider rule.

15. A method comprising:
generating a plurality of input signals associated with each of a plurality of pairs of contacts positioned on corresponding pairs of locations on a glove where knuckles of fingers are bent, the glove being made of conductive materials, the finger region between each of the pairs of contacts having a resistance value that changes as the corresponding finger region of the glove is unbent and bent; and
processing the plurality of input signals to generate output signals indicative of whether the finger regions of the glove are bent or unbent.

16. The method of claim 15, further comprising:
converting, using a plurality of A/D converters, the input signals as a measured analog voltage of each of the pairs of contacts into a digital signals.

17. The method of claim 16, wherein generating a plurality of signals further comprises generating a plurality of signals using a corresponding plurality of output resistors that are coupled each of the first contacts and A/D converters.

18. The method of claim 17, wherein the measurement of the analog voltage of each of the pairs of contacts is performed by measuring a terminal voltage of an internal resistance of each of the pairs of contacts between each of output resistors and the internal resistance value of each of the pairs of contacts according to a voltage divider rule.

19. The method of claim 15, further comprising supplying power to the data processing unit using a power unit.

20. The method of claim 15, further comprising receiving the data processed in the data processing unit and transmitting the processed data using a communication module.
